(19) United States
(12) Patent Application Publication
(10) Pub. No.: US 2023/0141753 A1
(43) Pub. Date: May 11, 2023

(54) LIDAR AND DETECTION METHOD USING THE SAME

(71) Applicant: HESAI TECHNOLOGY CO., LTD., Shanghai (CN)

(72) Inventors: Kai SUN, SHANGHAI (CN); Ying MENG, SHANGHAI (CN); Shaoqing XIANG, SHANGHAI (CN)

(21) Appl. No.: 18/091,820

(22) Filed: Dec. 30, 2022

Related U.S. Application Data
(63) Continuation of application No. PCT/CN2021/082802, filed on Mar. 24, 2021.

(30) Foreign Application Priority Data
Jul. 23, 2020 (CN) 202010727862.X

(51) Int. Cl. G01S 7/4911; G01S 17/32

(52) U.S. Cl. CPC G01S 7/4911; G01S 17/32

(57) ABSTRACT

A lidar includes a ranging module, a visible light emitting module, and a control circuit. The ranging module includes: a laser emitting unit, configured to emit a detection laser beam for detecting a target object; a light sensor unit is configured to receive an echo of the detection laser beam reflected by the target object and convert the echo into an electrical signal. A processor is connected to the light sensor unit to receive the electrical signal, and calculate a distance and/or reflectivity of the target object according to the electrical signal. The visible light emitting module is configured to emit a visible light to the outside of the lidar. The control circuit is coupled to the visible light emitting module and is configured to control the visible light emitting module to emit the visible light under a specific condition.

### CROSS-REFERENCE TO RELATED APPLICATIONS

This application is a Continuation Application of International Patent Application No. PCT/CN2021/082802, filed on Mar. 24, 2021, which is based on and claims priority to and benefits of Chinese Patent Application No. 202010727862.X, filed on Jul. 23, 2020. The entire content of all of the above identified applications is incorporated herein by reference.

### TECHNICAL FIELD

The present disclosure generally relates to the technical field of laser detection, and in particular, to a lidar including a visible light emitting module, and a detection method using the same.

### BACKGROUND

With the promotion of vehicle-mounted lidars, in the future, the possibility of users and pedestrians being exposed to laser radiation of the lidars at close distance becomes higher and higher. For security concerns, a lidar generally needs to comply with Class I human eye safety standard. As an active measurement manner, more powerful laser radiation emitted by a lidar means a better ranging performance, and laser pulses having denser arrangements need to be emitted into a space. However, the Class I laser product standard limits a maximum value to the laser radiation that a laser product can emit, thus limiting the detection performance of the lidar. However, safety is a fundamental consideration that a lidar must meet.

The content of “Background” merely represents technologies known to the inventor, and does not represent prior art in the field.

### SUMMARY

In view of at least one defect in the prior art, the present disclosure provides a lidar, including:
a ranging module, including:
a laser emitting unit, configured to emit a detection laser beam for detecting a target object;
a light sensor unit, configured to receive an echo of the detection laser beam reflected by the target object and convert the echo into an electrical signal; and
a processor, connected to the light sensor unit to receive the electrical signal, and calculate a distance and/or reflectivity of the target object according to the electrical signal;
a visible light emitting module, configured to emit a visible light to the outside of the lidar; and
a control circuit, coupled to the visible light emitting module, and configured to control the visible light emitting module to emit the visible light under a specific condition.

According to an aspect of the present disclosure, the control circuit is configured to control the visible light emitting module to continuously emit the visible light while the lidar is in operation.

According to an aspect of the present disclosure, the control circuit is configured to control the visible light emitting module to emit the visible light when energy or power of the detection laser beam emitted by the laser emitting unit is higher than a safety threshold for a human eye.

According to an aspect of the present disclosure, the control circuit is configured to control the visible light emitting module to emit the visible light when the intensity of the ambient light is lower than a preset light intensity.

According to an aspect of the present disclosure, the control circuit is configured to control the visible light emitting module to emit the visible light when the target object is within a predetermined distance.

According to an aspect of the present disclosure, the predetermined distance is determined according to a comparison between laser energy or power actually received by human eyes and the safety threshold for the human eye.

According to an aspect of the present disclosure, the control circuit communicates with the ranging module to obtain a distance between the target object and the lidar, to control the visible light emitting module to emit the visible light when the target object is within the predetermined distance (i.e., the distance between the target object and the lidar is less than the predetermined distance).

According to an aspect of the present disclosure, the lidar further includes a distance sensor, the distance sensor is configured to measure the distances between target objects and the lidar, and the control circuit communicates with the distance sensor to obtain the distances of target objects, to control the visible light emitting module to emit the visible light when the target object is within the predetermined distance.

According to an aspect of the present disclosure, the control circuit obtains a distance between the target object and the lidar from another sensing system external to the lidar, to control the visible light emitting module to emit the visible light when the target object is within the predetermined distance.

According to an aspect of the present disclosure, the lidar further includes a first scanning module, configured to deflect the incident detection laser beam and the incident visible light to the outside of the lidar, where the visible light emitted by the visible light emitting module and a laser emitted by the laser emitting unit of the ranging module are emitted along the same optical path.

According to an aspect of the present disclosure, the lidar further includes a second scanning module, configured to deflect the incident detection laser beam to the outside of the lidar for detecting the target object, where the visible light emitted by the visible light emitting module and a laser emitted by the laser emitting unit of the ranging module are emitted along different optical paths.

According to an aspect of the present disclosure, the lidar includes a plurality of visible light emitting modules, and light emitted by the plurality of visible light emitting modules are directed to different vertical fields of view.

According to an aspect of the present disclosure, the lidar further includes a third scanning module, configured to deflect the incident visible light to the outside of the lidar and scan the light within a range of a vertical field of view.

According to an aspect of the present disclosure, the visible light emitting module and the ranging module are capable of synchronously rotating around a rotary shaft of the lidar.

According to an aspect of the present disclosure, the lidar includes a plurality of visible light emitting modules that are non-rotatably fixed on the lidar, the ranging module is capable of rotating around a rotary shaft of the lidar, the plurality of visible light emitting modules correspond to different horizontal angle ranges of the lidar respectively, and the control circuit is configured to sequentially control the corresponding visible light emitting modules to emit visible light when the ranging module rotates.

According to an aspect of the present disclosure, the visible light emitting module is located outside a window or an optical housing of the lidar.

According to an aspect of the present disclosure, the visible light emitting module is located inside the lidar, and emits the visible light to the outside of the lidar through a window or an optical housing.

The present disclosure further provides a detection method using the lidar described above, including:
S101: Emitting a detection laser beam from a ranging module of the lidar for detecting a target object; and
S102: Controlling a visible light emitting module of the lidar to emit a visible light under a specific condition.

According to an aspect of the present disclosure, step S102 includes: controlling the visible light emitting module to continuously emit the visible light while the lidar is in operation.

According to an aspect of the present disclosure, step S102 includes: controlling the visible light emitting module to emit the visible light when energy or power of the detection laser beam emitted by the laser emitting unit is higher than a safety threshold for a human eye.

According to an aspect of the present disclosure, step S102 includes: controlling the visible light emitting module to emit the visible light when the intensity of the ambient light is lower than a preset light intensity.

According to an aspect of the present disclosure, step S102 includes: controlling the visible light emitting module to emit the visible light when the target object is within a predetermined distance.

According to an aspect of the present disclosure, the method further includes one or more of the following steps:
obtaining a distance between the target object and the lidar from the ranging module;
obtaining the distance between the target object and the lidar from a distance sensor; and
obtaining the distance between the target object and the lidar from another sensing system external to the lidar.

The embodiments of the present disclosure provide a lidar including a visible light emitting module. Under control of a control circuit, the visible light emitting module emits a visible light under one or a combination of several conditions of 1) continuously emitting, 2) energy or power of a detection laser beam is higher than a safety threshold for a human eye, 3) the intensity of the ambient light is lower than a preset light intensity, and 4) a target object is within a predetermined distance. Emitting the visible light reduces aperture of pupils of an observer or triggers an escape reflex, so that the emitting power of the lidar is improved under the condition of human eye-safe, thereby improving the detection performance of the lidar.

### BRIEF DESCRIPTION OF THE DRAWINGS

The accompanying drawings are used to provide a further understanding of the present disclosure, and constitute a part of the specification, are used to explain the present disclosure in combination with the embodiments of the present disclosure, and do not constitute a limitation to the present disclosure. In the accompanying drawings:

FIG. 1 schematically shows a lidar according to an embodiment of the present disclosure;

FIG. 2 schematically shows a lidar according to an embodiment of the present disclosure;

FIG. 3 schematically shows a lidar according to an embodiment of the present disclosure;

FIG. 4 schematically shows a lidar according to an embodiment of the present disclosure;

FIG. 5 schematically shows a lidar according to an embodiment of the present disclosure;

FIG. 6 schematically shows a lidar according to an embodiment of the present disclosure;

FIG. 7 schematically shows a lidar according to an embodiment of the present disclosure;

FIG. 8 schematically shows a lidar according to an embodiment of the present disclosure;

FIG. 9 schematically shows a lidar according to an embodiment of the present disclosure;

FIG. 10A schematically shows relative position of a visible light emitting module and a window according to an embodiment of the present disclosure;

FIG. 10B schematically shows relative position of a visible light emitting module and an optical housing according to an embodiment of the present disclosure;

FIG. 11A schematically shows relative position of a visible light emitting module and a window according to an embodiment of the present disclosure;

FIG. 11B schematically shows relative position of a visible light emitting module and an optical housing according to an embodiment of the present disclosure;

FIG. 12 schematically shows a detection method using a lidar according to an embodiment of the present disclosure.

### DETAILED DESCRIPTION OF EMBODIMENTS

Only certain exemplary embodiments are briefly described below. As those skilled in the art can realize, the described embodiments may be modified in various different ways without departing from the spirit or the scope of the present disclosure. Therefore, the accompanying drawings and the description are to be considered illustrative in nature but not restrictive.

In the description of the present disclosure, it should be understood that directions or location relationships indicated by terms “center”, “longitudinal”, “landscape”, “length”, “width”, “thickness”, “upper”, “lower”, “front”, “rear”, “left”, “right”, “vertical”, “horizontal”, “top”, “bottom”, “inner”, “outer”, “clockwise”, and “counterclockwise” are directions or location relationships shown based on the accompanying drawings, are merely used for the convenience of describing the present disclosure and simplifying the description, but are not used to indicate or imply that a device or an element must have a particular direction or must be constructed and operated in a particular direction, and therefore, cannot be understood as a limitation to the present disclosure. In addition, the terms “first” and “second” are used for descriptive purposes only and are not to be construed as indicating or implying relative importance or implicitly indicating the number of technical features indicated. Thus, features defined by “first” and “second” may explicitly or implicitly include one or more of the features. In the descriptions of the present disclosure, unless otherwise explicitly specified, “plurality of” means two or more than two.

In the descriptions of the present disclosure, it should be noted that, unless otherwise explicitly stipulated and restricted, terms “installation”, “connection”, and “connect with” should be understood broadly, which, for example, may be a fixed connection, or may be a detachable connection, or an integral connection; or may be a mechanical connection, or may be an electrical connection, or may be mutual communication; or the connection may be a direct connection, an indirect connection through an intermediate, or internal communication between two elements or an interaction relationship between two elements. The specific meanings of the above terms in the present disclosure may be understood according to specific circumstances for a person of ordinary skill in the art.

In the present disclosure, unless otherwise explicitly stipulated and restricted, that a first feature is “above” or “under” a second feature may include that the first and second features are in direct contact, or may include that the first and second features are not in direct contact but in contact by using other features therebetween. In addition, that the first feature is “on”, “above”, or “over” the second feature includes that the first feature is right above and obliquely above the second feature, or merely indicates that a horizontal height of the first feature is higher than that of the second feature. That the first feature is “below”, “under”, or “beneath” the second feature includes that the first feature is right below and obliquely below the second feature, or merely indicates that a horizontal height of the first feature is lower than that of the second feature.

Many different implementations or examples are provided in the following disclosure to implement different structures of the present disclosure. To simplify the disclosure of the present disclosure, components and settings of specific examples are described below. Certainly, the components and settings are merely examples and are not intended to limit the present disclosure. In addition, in the present disclosure, reference numerals and/or reference letters may be repeated in different examples. The repetition is for the purposes of simplification and clearness, and does not indicate a relationship between various implementations and/or settings discussed. Moreover, the present disclosure provides examples of various specific processes and materials, but a person of ordinary skill in the art may be aware of application of another process and/or use of another material.

Embodiments of the present disclosure are described below in detail with reference to the accompanying drawings. It should be understood that the y embodiments described herein are merely used to illustrate and explain the present disclosure, but are not intended to limit the present disclosure.

According to an embodiment of the present disclosure, as shown in FIG. 1, the present disclosure provides a lidar 10, including a ranging module 11, a visible light emitting module 12, and a control circuit 13. The ranging module 11 is configured to emit a detection laser beam to measure a distance of a target object, and includes a laser emitting unit 110, a light sensor unit 111, and a processor 112. The laser emitting unit 110 includes one or more laser emitters, and is configured to emit a detection laser beam for detecting the target object. The light sensor unit 111 is configured to receive an echo of the detection laser beam reflected by the target object and convert the echo into an electrical signal. The processor 112 is connected to the light sensor unit 111 to receive the electrical signal, and calculate a distance and/or reflectivity of the target object according to the electrical signal. The visible light emitting module 12 is configured to emit a visible light to the outside of the lidar. The control circuit 13 is coupled to the visible light emitting module 12 and is configured to control the visible light emitting module 12 to emit the visible light under a specific condition.

As mentioned above, as the lidar becomes more and more widely used, the possibility of people being exposed to laser radiation of the lidar at close distance become higher and higher. Moreover, as an active measurement manner, more powerful and denser laser radiation emitted by the lidar indicates a better detection performance. Therefore, in order to obtain a farther detection distance and a higher spatial resolution, higher-power and denser laser pulses need to be emitted. In addition, the laser used by the lidar is near-infrared light in most cases, which is invisible to human vision and cannot make human eyes perform reflex adjustment. Therefore, if laser power is too high, it is very likely that certain damage to the human eyes has been caused in a case that the people around the lidar does not notice. Therefore, the Class I laser product standard limits a maximum value to the laser radiation that a laser product can emit, thus limiting the detection performance of the lidar.

The inventor of the present disclosure has conceived that, a visible light is used to stimulate pupil adjustment of eyes or trigger an escape reflex. By using characteristics that pupillary sphincters on irises can control contraction and relaxation of pupils when human eyes are affected by an ambient light and that visible light with a certain intensity can reduce the aperture of pupils of an observer or cause an escape reflex, the avoidance of a laser safety risk and the improvement the detection capability of the lidar together with the surety of the safety of the user can be achieved. When a person is suddenly exposed to more powerful visible light, aperture of pupils thereof is promptly reduced. By using the characteristic that the aperture of the pupils of the observer is reduced or the escape reflex is produced, it can be achieved that the aperture of the pupils of the observer can be kept in a smaller state during the lidar ranging process or when an object exists in a distance of a safety risk of the lidar. Therefore, laser energy entering the eyes of the observer is reduced, thereby ensuring the safety of the lidar in foreseeable usage scenarios. In other words, even if the emitting power of the lidar is higher, because the aperture of the pupils of the observer is smaller in this case, only a small part of laser energy enters the pupils compared to normal aperture of the pupils, so that the safety of the human eyes can be ensured.

The control circuit 13 can control the visible light emitting module 12 to emit the visible light according to a plurality of strategies. Details are described below.

According to an embodiment of the present disclosure, the control circuit 13 is configured to control the visible light emitting module 12 to continuously emit the visible light while the lidar 10 is in operation. During the lidar ranging process, the visible light is continuously emitted, so that aperture of pupils of an observer around the lidar is reduced, and a laser near-infrared light entering the pupils whose aperture is reduced is within a threshold of the Class I laser product, or an escape reflex of the people is triggered to make eyes subconsciously move away. By controlling the visible light emitting module 12 to continuously emit the visible light in the operating process of the lidar 10, it can be ensured that the aperture of the pupils of the observer around the lidar are in a reduced state. The visible light emitted by the visible light emitting module 12 may be a continuous wave and/or a directly emitted light without passing through a collimation system to cover a larger range of a field of view.

According to an embodiment of the present disclosure, the control circuit 13 is configured to control the visible light emitting module 12 to emit the visible light when energy or power of the detection laser beam emitted by the laser emitting unit 110 is higher than a safety threshold for a human eye. The safety threshold of the lidar may be pre-calculated and set. For example, a safety threshold of a laser product may be calculated according to a laser safety standard (such as IEC 60825-1:2014), and an emission characteristic of the laser product needs to be considered in the calculation process. Laser products are classified from Class I to Class IV, and laser products with Class I are safe and harmless. The above safety threshold for the human eye refers to a safety threshold of Class I. By using a pulsed lidar as an example, calculation of a safety threshold not only needs to consider a size of a beam imaged on a retina and a proportion of the beam entering a pupil, but also needs to consider spatial distribution and timing characteristics of laser pulses, which are reflected on different parameters in the calculation of the threshold. In addition, for the laser pulses, repeated laser pulses are also affected by a correction factor, and the threshold decreases with an increase of a quantity of pulses in a period of time, that is, long-time pulses produce a superposition effect so that the threshold value decreases. In addition, different laser emitters of the lidar may correspond to different fields of view and detection distances, and thus have different emitting power or energy. In a continuous detection process, according to emission power or energy of a laser emitter that is currently emitting light, the power or energy is compared with a preset safety threshold for a human eye. If the power or energy is higher than the safety threshold for the human eye, the control circuit 13 controls the visible light emitting module 12 to emit the visible light, to stimulate aperture of pupils of people to be reduced and avoid laser damage. If the power or energy is lower than the safety threshold for the human eye, the control circuit 13 does not need to control the visible light emitting module 12 to emit the visible light. That is because an emission intensity in this case is safe and does not cause damage to human eyes.

According to an embodiment of the present disclosure, the control circuit 13 is configured to control the visible light emitting module 12 to continuously emit the visible light when the intensity of the ambient light is lower than a preset light intensity. When the intensity of the ambient light is higher, aperture of pupils of human eyes is usually smaller. In this case, even if emission power of the lidar is higher, damage is not caused to the human eyes. When the intensity of the ambient light is lower, the aperture of the pupils of the human eyes is usually larger to clearly see surrounding environment. In this case, a laser emitted by the lidar is easy to cause damage to the human eyes. A threshold specified in a laser safety standard is energy or power that actually enters a pupil. A current laser safety standard often assumes that a size of the pupil is 7 mm, which represents maximum aperture that the pupil in people can reach in the dark under typical circumstances. Under a typical daylight, the pupil tends to be only 2 to 3 mm. If an opening size of the pupil decreases, laser energy or power that enters an eyeball and is absorbed by an eye tissue decreases, and a safety threshold of the laser energy or power calculated according to the laser safety standard increases, so that the lidar can emit a more powerful laser to achieve a better detection capability. For example, if a safety threshold calculated after the size of the pupil decreases is a first threshold, and a safety threshold calculated according to the size of the pupil with 7 mm is a second threshold, the first threshold is larger than the second threshold. The intensity of the ambient light may be calculated according to one or more of current date, time, and weather. Or, in some embodiments, the intensity of the ambient light may be measured directly. For example, in a light-emitting gap of the laser emitting unit 110 of the lidar, in this case, an output of the light sensor unit 111 may represent the intensity of the ambient light. The lidar may pre-store a relationship between the intensity of the ambient light and the size of the pupil. The actual intensity of the ambient light may be used to estimate the size of the pupil, and then the estimated size of the pupil may be used as a factor for determining whether laser power exceeds the safety threshold. For example, when the intensity of the ambient light is higher, the estimated size of the pupil is 2 mm, and the lidar may emit the laser according to the first threshold. When the intensity of the ambient light becomes low, the opening size of the pupil increases, and light energy that enters the eyeball and is absorbed by the eye tissue increases. In this case, the visible light is emitted, so that aperture of pupils of an observer is reduced or an escape reflex is triggered, thereby ensuring the usage safety of the lidar.

According to an embodiment of the present disclosure, the control circuit 13 is configured to control the visible light emitting module 12 to emit the visible light when the target object is within a predetermined distance. A laser attenuates during a propagation process. Therefore, even if a laser emitter has high emission power, an intensity of an emitted laser attenuates after propagating a certain distance, which has almost no effect on human eyes. Therefore, in a case that an observer is located within the predetermined distance (where the predetermined distance is larger than or equal to a risk distance), the lidar actively emits the visible light, so that aperture of pupils of the observer is reduced, and a laser near-infrared light entering the pupils whose aperture is reduced within a range of the risk distance is within a threshold of the Class I laser product, or an escape reflex of the people is triggered to make eyes subconsciously move away. Due to a damage superposition effect of laser pulses, when an object is detected in the risk distance, the visible light is promptly emitted, so that aperture of the pupils of the observer is reduced, and light radiation received by the observer in a short time and a long time is within the safety threshold of the Class I laser product, or the escape reflex of the people is stimulated to move the eyes away subconsciously. The risk distance is determined according to a comparison between laser energy or power actually received by human eyes and the safety threshold for the human eye. Herein, for example, the risk distance is calculated according to the size of the pupil with 7 mm set in the laser safety standard. In the range of the risk distance, the laser energy or power actually received by the human eyes is higher than the safety threshold for the human eye. Out of the range of the risk distance, the laser energy or power actually received by the human eyes is lower than the safety threshold for the human eye. For example, the predetermined distance is the same as the risk distance, or is larger than the risk distance according to a system requirement.

Those skilled in the art can easily understand that, the control circuit 13 may control the visible light emitting module 12 to emit the visible light according to one or more of factors such as the energy or power of the detection laser beam emitted by the laser emitting unit 110, the intensity of the ambient light, and the predetermined distance.

For detection of the distance between the target object and the lidar, according to an embodiment of the present disclosure, the control circuit 13 communicates with the ranging module 11 to obtain the distance between the target object and the lidar, to control the visible light emitting module 12 to emit the visible light when the target object is within the predetermined distance.

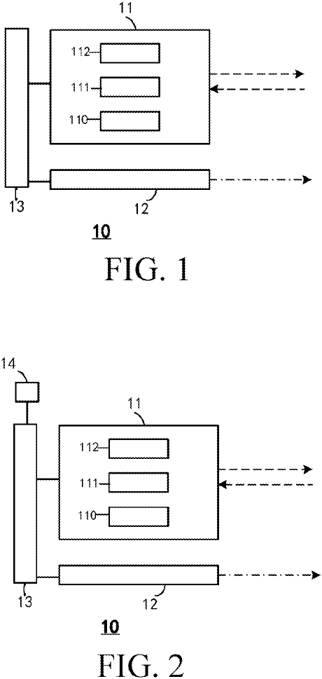

Additionally, or alternatively, according to an embodiment of the present disclosure, as shown in FIG. 2, the lidar 10 further includes a distance sensor 14, the distance sensor 14 is configured to measure the distances between target objects and the lidar 10, and the control circuit 13 communicates with the distance sensor 14 to obtain the distances of target objects, to control the visible light emitting module 12 to emit the visible light when the target object is within the predetermined distance. The distance sensor 14 includes, for example, one or more of an ultrasonic radar and a proximity sensor.

According to an embodiment of the present disclosure, as shown in FIG. 3, the control circuit 10 obtains the distance between the target object and the lidar from another sensing system 15 external to the lidar 10, to control the visible light emitting module 12 to emit the visible light when the target object is within a predetermined distance. The another sensing system 15 may transmit distance information to the lidar 10 in a wired or wireless transmission manner.

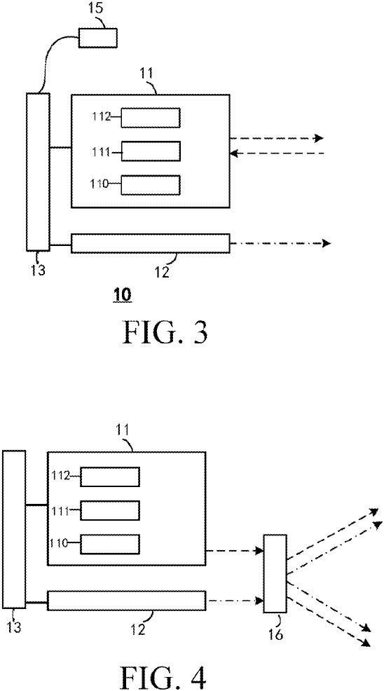

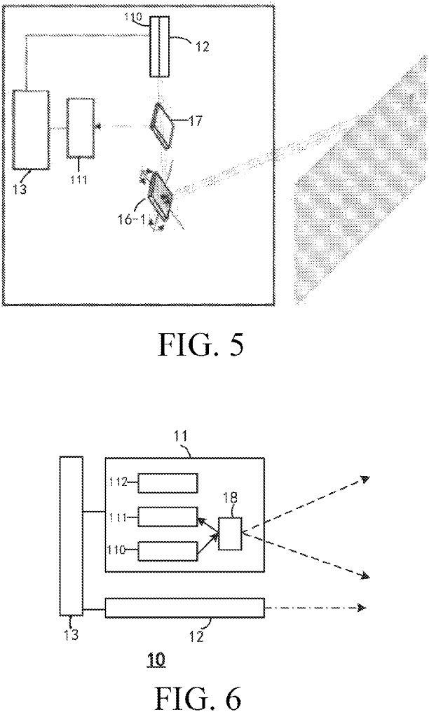

According to an embodiment of the present disclosure, as shown in FIG. 4, the lidar 10 further includes a first scanning module 16, configured to deflect the incident detection laser beam and the incident visible light to the outside of the lidar, and covers a certain range of a field of view through a scanning action of the first scanning module 16. The visible light emitted by the visible light emitting module 12 and the detection laser beam emitted by the laser emitting unit 110 of the ranging module 11 are emitted along the same optical path. In a returning optical path, for example, a filter is usually arranged on a receiving lens or in front of a detector, and a wavelength of the visible light is outside a passband of the filter, so that the visible light is not returned to the detector. FIG. 4 shows an implementation structure of a scanning device. The visible light emitted by the visible light emitting module 12 and an infrared laser emitted by the ranging module 11 perform one-dimensional/two-dimensional field of view scanning through the first scanning module 16. The first scanning module 16 may be a vibrating mirror, an oscillating mirror, a multi-faceted rotating mirror, or the like. FIG. 5 shows a specific implementation structure of a scanning device using a vibrating mirror 16-1. The structure further includes a light splitting module 17, and the light splitting module 17 may be, for example, a semi-transparent and semi-reflective mirror. As shown in FIG. 5, the infrared laser emitter 110 of the ranging module 11 emits the infrared laser, the visible light emitting module 12 is controlled by the control circuit 13 to emit the visible light in a certain condition, the infrared laser and the visible light are emitted to the outside after passing through the light splitting module 17 and the vibrating mirror 16-1 together, and echoes reflected by an external object are received by a detector 111 of the ranging module 11 after passing through the vibrating mirror 16-1 and the light splitting module 17. A part of the echo of the visible light is filtered out before reaching the detector 111. The visible light emitting module 12 includes, for example, one or more of a light emitting diode (LED) and a laser diode (LD).

According to an embodiment of the present disclosure, as shown in FIG. 6, the lidar 10 further includes a second scanning module 18, configured to deflect the incident detection laser beam to the outside of the lidar for detecting the target object, and covers a certain range of a field of view through a scanning action of the first scanning module 18. In some embodiments, as shown in FIG. 6, the visible light emitted by the visible light emitting module 12 and the detection laser beam emitted by the laser emitting unit 110 of the ranging module 11 are emitted along different optical paths, so as to reduce the interference to ranging. FIG. 6 shows an implementation structure of a scanning device. An infrared laser emitted by the ranging module 11 perform one-dimensional/two-dimensional field of view scanning through the second scanning module 18. The visible light emitted by the visible light emitting module 12 is directly emitted without passing through the second scanning module 18.

According to an embodiment of the present disclosure, FIG. 7 shows a specific implementation structure of another scanning device using a vibrating mirror 18-1. The structure further includes a light splitting module 17, and the light splitting module 17 may be, for example, a semi-transparent and semi-reflective mirror. As shown in FIG. 7, the infrared laser emitter 110 of the ranging module 11 emits the infrared laser, the infrared laser is emitted to the outside after passing through the light splitting module 17 and the vibrating mirror 18-1, and an echo reflected by an external object is received by a detector 111 of the ranging module 11 after passing through the vibrating mirror 18-1 and the light splitting module 17. The visible light emitting module 12 is controlled by the control circuit 13 to emit the visible light in a certain condition, and the visible light emitted by the visible light emitting module 12 is directly emitted without passing through the vibrating mirror 18-1.

In addition, according to an embodiment of the present disclosure, the lidar 10 includes a plurality of visible light emitting modules 12, and the light emitted by the plurality of visible light emitting modules 12 are directed to different vertical and/or horizontal fields of view. By arranging the plurality of visible light emitting modules 12, a range of a field of view scanned by the second scanning module 18 can be covered.

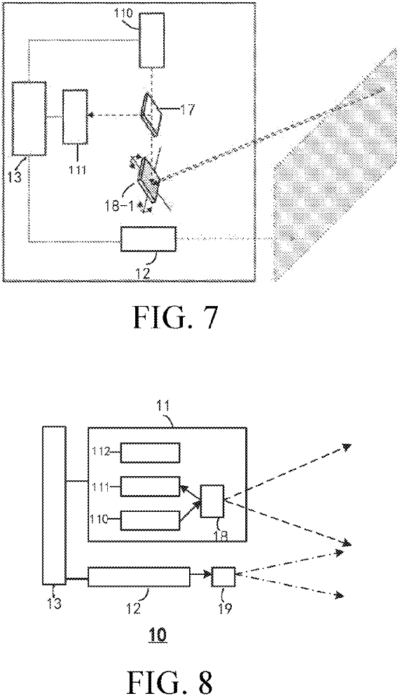

According to an embodiment of the present disclosure, as shown in FIG. 8, the lidar 10 further includes a third scanning module 19, configured to deflect the incident visible light to the outside of the lidar and scan the light within a range of a vertical and/or horizontal field of view. For example, the third scanning module 19 scans the visible light emitted by the visible light emitting module 12 in a vertical direction, so as to ensure that eyes of observers with different heights can be illuminated by the visible light. For example, the third scanning module 19 may also scan the visible light emitted by the visible light emitting module 12 in a horizontal direction, so as to ensure that eyes of observers in a certain range of a horizontal field of view can be illuminated by the visible light. For example, the range of the field of view scanned by the third scanning module 19 may overlap or partially overlap with the range of the field of view scanned by the second scanning module 18. In addition, a scanning angle of the visible light and a scanning angle of the laser have a predetermined deviation.

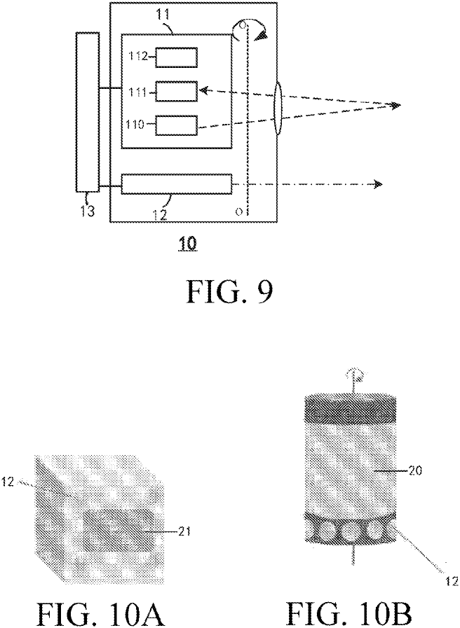

According to an embodiment of the present disclosure, as shown in FIG. 9, the visible light emitting module 12 and the ranging module 11 may synchronously rotate around a rotary shaft 0-0 of the lidar 10. The laser emitting unit 110 of the ranging module 11 and the light sensor unit 111 rotate 360° around the rotary shaft 0-0, the visible light emitting module 12 and the ranging module 11 synchronously rotate 360° around the rotary shaft 0-0 (that is, keeps horizontal field of view angles whose pointing directions are same), and the visible light emitting module 12 is controlled by the control circuit 13 to emit the visible light in a certain condition, so as to ensure the safety of human eyes in a current detection field of view of the lidar.

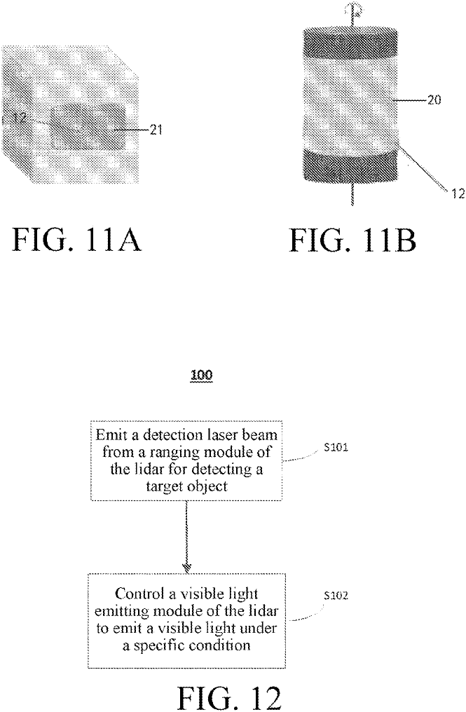

According to an embodiment of the present disclosure, the ranging module 11 may rotate around the rotary shaft 0-0 of the lidar, the plurality of visible light emitting modules 12 are non-rotatably fixed on the lidar and correspond to different horizontal angle ranges of fields of view of the lidar respectively, and the control circuit 13 is configured to sequentially control the corresponding visible light emitting modules 12 to emit visible light when the ranging module 11 rotates. As shown in FIG. 10B and FIG. 11B, the plurality of visible light emitting modules 12 are arranged on a base of the lidar and cannot rotate. The laser emitting unit 110 of the ranging module 11 and the light sensor unit 111 rotate 360° around the rotary shaft, the plurality of visible light emitting modules 12 are arranged 360° along the lidar 10 (that is, do not rotate), and in an operating process of the ranging module 11, the visible light emitting modules 12 are controlled by the control circuit 13 to emit the visible light in a certain condition. For example, when the ranging module 11 rotates to a certain angle, a visible light emitting module 12 corresponding to a current horizontal angle is controlled to emit the visible light in the certain condition. At this angle, the visible light emitting module 12 may emit the light earlier than the ranging module 11 (according to data of the distance sensor or the another sensing system), so as to play an early warning role, so that aperture of pupils of observers is reduced or an escape reflex is triggered.

According to an embodiment of the present disclosure, as shown in FIG. 10A and FIG. 10B, the visible light emitting module 12 may be located outside the lidar 10, for example, located outside a window 21 or an optical housing 20. in some embodiments, according to an embodiment of the present disclosure, as shown in FIG. 11A and FIG. 11B, the visible light emitting module 12 may be located inside the lidar 10, and emit the visible light to the outside of the lidar 10 through the window 21 or the optical housing 20. When the visible light emitting module 12 is located inside the lidar 10, a window 21/optical housing 20 matching the visible light emitting module needs to be selected to be emitted.

Similar to the arrangement manner of the above visible light emitting module 12, the above distance sensor 14 may also be arranged according to a rotatable manner or a non-rotatable manner. For example, for a scanning lidar, the distance sensor 14 is arranged on a front panel of the lidar; and for a rotary lidar, the distance sensor 14 may be arranged on the top or a base of the lidar in a non-rotatable manner, or may synchronously rotate with the ranging module 11.

According to an embodiment of the present disclosure, as shown in FIG. 12, the present disclosure further provides a detection method 100 using the lidar 10 described above, including:

In step S101, emitting a detection laser beam from a ranging module of the lidar for detecting a target object.

In step S102, controlling a visible light emitting module of the lidar to emit a visible light under a specific condition.

According to an embodiment of the present disclosure, step S102 further includes one or more of the following steps:
controlling the visible light emitting module to continuously emit the visible light while the lidar is in operation;
controlling the visible light emitting module to emit the visible light when energy or power of the detection laser beam emitted by the laser emitting unit is higher than a safety threshold for a human eye;
controlling the visible light emitting module to emit the visible light when the intensity of the ambient light is lower than a preset light intensity; and
controlling the visible light emitting module to emit the visible light when the target object is within a predetermined distance.
According to an embodiment of the present disclosure, the detection method 100 further includes one or more of the following steps:
obtaining a distance between the target object and the lidar from the ranging module;
obtaining the distance between the target object and the lidar from a distance sensor; and
obtaining the distance between the target object and the lidar from another sensing system external to the lidar.

The embodiments of the present disclosure provide a lidar including a visible light emitting module. Under control of a control circuit, the visible light emitting module emits a visible light under one or a combination of several conditions of 1) continuously emitting, 2) energy or power of a detection laser beam is higher than a safety threshold for a human eye, 3) the intensity of the ambient light is lower than a preset light intensity, and 4) a target object is within a predetermined distance. Emitting the visible light reduces aperture of pupils of an observer or triggers an escape reflex, so that the emitting power of the lidar is improved under the condition of human eye-safe, thereby improving the detection performance of the lidar.

It should be finally noted that the foregoing descriptions are merely embodiments of the present disclosure, but are not intended to limit the present disclosure. Although the present disclosure has been described in detail with reference to the foregoing embodiments, for a person of ordinary skill in the art, modifications can be made to the technical solutions described in the foregoing embodiments, or equivalent replacements can be made to some technical features in the technical solutions. Any modification, equivalent replacement, or improvement made within the spirit and principle of the present disclosure shall fall within the protection scope of the present disclosure.

What is claimed is:

1. A lidar, comprising:
a ranging module, comprising:
a laser emitting unit, configured to emit a detection laser beam for detecting a target object;
a light sensor unit, configured to receive an echo of the detection laser beam reflected by the target object and convert the echo into an electrical signal; and
a processor, connected to the light sensor unit to receive the electrical signal, and calculate a distance and/or reflectivity of the target object according to the electrical signal;
a visible light emitting module, configured to emit a visible light to an outside of the lidar; and
a control circuit, coupled to the visible light emitting module, and configured to control the visible light emitting module to emit the visible light under a specific condition.

2. The lidar according to claim 1, wherein the control circuit is configured to control the visible light emitting module to continuously emit the visible light while the lidar is in operation.

3. The lidar according to claim 1, wherein the control circuit is configured to control the visible light emitting module to emit the visible light when energy or power of the detection laser beam emitted by the laser emitting unit is higher than a safety threshold for a human eye.

4. The lidar according to claim 1, wherein the control circuit is configured to control the visible light emitting module to emit the visible light when the intensity of the ambient light is lower than a preset light intensity.

5. The lidar according to claim 1, wherein the control circuit is configured to control the visible light emitting module to emit the visible light when a distance between the target object and the lidar is less than a predetermined distance.

6. The lidar according to claim 5, wherein the predetermined distance is determined according to a comparison between laser energy or power received by human eyes and the safety threshold for the human eye.

7. The lidar according to claim 5, wherein the control circuit communicates with the ranging module to obtain the distance between the target object and the lidar, and controls the visible light emitting module to emit the visible light when the distance is less than the predetermined distance.

8. The lidar according to claim 5, wherein the lidar further comprises a distance sensor, the distance sensor is configured to measure the distance between the target object and the lidar, and the control circuit communicates with the distance sensor to obtain the distance, and controls the visible light emitting module to emit the visible light when the distance is less than the predetermined distance.

9. The lidar according to claim 5, wherein the control circuit obtains the distance from a sensing system external to the lidar, and controls the visible light emitting module to emit the visible light when the distance is less than the predetermined distance.

10. The lidar according to claim 1, further comprising a scanning module, configured to deflect the detection laser beam and the visible light to an outside of the lidar, wherein the visible light emitted by the visible light emitting module and the detection laser beam emitted by the laser emitting unit of the ranging module are emitted along a same optical path.

11. The lidar according to claim 1, further comprising a first scanning module, configured to deflect the detection laser beam to an outside of the lidar for detecting the target object, wherein the visible light emitted by the visible light emitting module and the detection laser beam emitted by the laser emitting unit of the ranging module are emitted along different optical paths.

12. The lidar according to claim 11, wherein the lidar comprises a plurality of visible light emitting modules including the visible light emitting module, and light beams emitted by the plurality of visible light emitting modules are directed to different vertical fields of view.

13. The lidar according to claim 11, further comprising a second scanning module, configured to deflect the visible light to the outside of the lidar and scan the light within a range of a vertical field of view.

14. The lidar according to claim 1, wherein the visible light emitting module and the ranging module are configured to synchronously rotate around a rotary shaft of the lidar.

15. The lidar according to claim 1, wherein the lidar comprises a plurality of visible light emitting modules including the visible light emitting module that are non-rotatably fixed on the lidar, the ranging module is configured to rotate around a rotary shaft of the lidar, the plurality of visible light emitting modules correspond to different horizontal angle ranges of the lidar respectively, and the control circuit is configured to control the visible light emitting modules to emit visible light when the ranging module rotates.

16. The lidar according to claim 1, wherein the visible light emitting module is located outside a window or an optical housing of the lidar.

17. The lidar according to claim 1, wherein the visible light emitting module is located inside the lidar, and emits the visible light to the outside of the lidar through a window or an optical housing.

18. A detection method using the lidar according to claim 1, the method comprising:
emitting the detection laser beam from the ranging module of the lidar for detecting the target object; and
controlling the visible light emitting module of the lidar to emit the visible light under the specific condition.

19. The detection method according to claim 18, wherein controlling the visible light emitting module of the lidar to emit the visible light under the specific condition comprises:
controlling the visible light emitting module to continuously emit the visible light while the lidar is in operation.

20. The detection method according to claim 18, wherein controlling the visible light emitting module of the lidar to emit the visible light under the specific condition comprises:
controlling the visible light emitting module to emit the visible light when energy or power of the detection laser beam emitted by the laser emitting unit is higher than a safety threshold for a human eye.
